(19) United States
(12) Patent Application Publication
(10) Pub. No.: US 2012/0168994 A1
(43) Pub. Date: Jul. 5, 2012

(54) MOLDING DEVICE AND METHOD FOR MOLDING A NUT INTO A COVER

(75) Inventors: JIAN-HUI DAI, Shenzhen City (CN); CHAO TANG, Shenzhen City (CN); JIE-YI SHU, Shenzhen City (CN); ZHONG-JIE LUO, Shenzhen City (CN); YU-TAO CHEN, Tu-Cheng (TW); TE-SHENG JAN, Tu-Cheng (TW); CHUN-CHE YEN, Tu-Cheng (TW)

(73) Assignees: HON HAI PRECISION INDUSTRY CO., LTD., Tu-Cheng (TW); HONG FU JIN PRECISION INDUSTRY (ZhenZhen) CO., LTD, Shenzhen City (CN)

(21) Appl. No.: 13/207,432

(22) Filed: Aug. 11, 2011

(30) Foreign Application Priority Data
Dec. 29, 2010 (CN) 201010612756.3

(51) Int. Cl. B29C 45/14

(52) U.S. Cl. 264/571; 425/546

(57) ABSTRACT

A method for molding a nut into a cover of an electronic device is provided. The nut includes a chassis defining a threaded blind hole therein. The method includes the following steps: providing a core mold, the core mold including a molding surface and a recess defined in the molding surface; placing the nut on the core mold with the chassis fittingly engaged in the recess; creating a negative pressure within the recess to firmly secure the chassis in the recess; attaching a cavity mold to the core mold, the cavity mold and the core mold cooperatively forming a molding cavity receiving the nut therein; and injecting molding material into the molding cavity to form the cover with the nut embedded therein. A molding device for molding the nut into the cover is also provided.

### BACKGROUND

1. Technical Field

The present disclosure relates to a molding device and a molding method for molding a nut into a cover.

2. Description of Related Art

A cover of an electronic device defines a number of threaded through holes for connecting components defining a number of connecting holes on the cover. The component may be a circuit board. A screw penetrates through the through hole and the connecting holes in sequence, and is screwed into a nut resisting on the lower surface of the component. The nut is usually integrally formed with the cover.

However, when a number of nuts with different sizes and shapes need embedding in the cover, each of the number of nuts is manually located to position in the molding process, which results in a lower yield of the molding process. Furthermore, when a number of blind holes instead of the though holes are defined in the cover for a better appearance of the electronic device, the melting process commonly used cannot mold the nuts into the cover.

Therefore, what is needed is a molding device and a molding method for molding a nut into a cover to alleviate the limitations described above.

### BRIEF DESCRIPTION OF THE DRAWINGS

The components in the drawings are not necessarily drawn to scale, the emphasis instead being placed upon clearly illustrating the principles of a molding device and a molding method for molding a nut into a cover. Moreover, in the drawings, like reference numerals designate corresponding parts throughout the several views.

FIG. 1 is an isometric view of an exemplary embodiment of a nut used in a molding method.

FIG. 2 is an isometric view of the nut of FIG. 1, viewed from another perspective.

FIG. 3 is a perspective view of the nut of FIG. 1 assembled with a molding device.

FIG. 4 is an exploded view of the nut and the molding device of FIG. 3.

FIG. 5 is a cross-sectional view of the nut and the molding device of FIG. 3, taken along lines of V-V.

FIG. 6 is a flowchart of a molding method for molding the nut of FIG. 1 into a cover of an electronic device.

### DETAILED DESCRIPTION

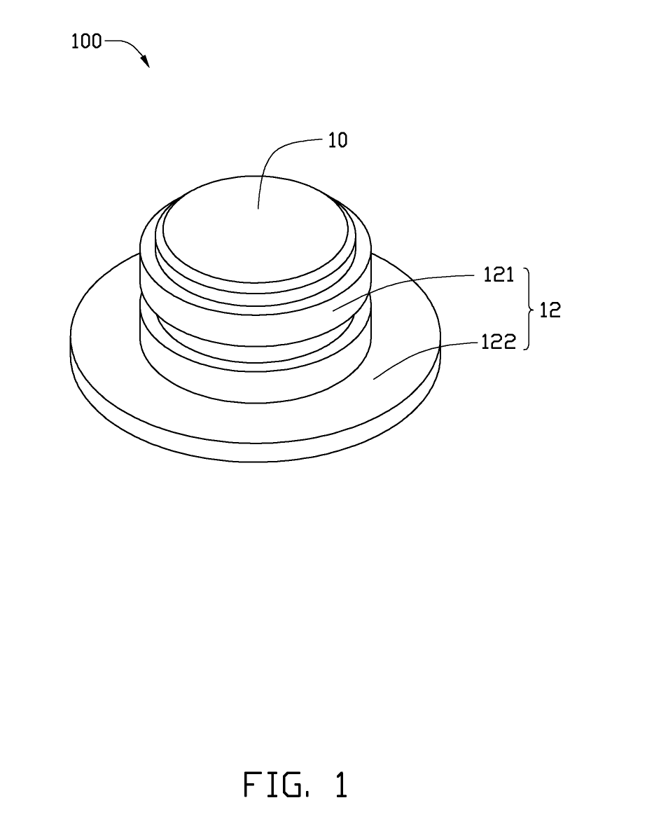

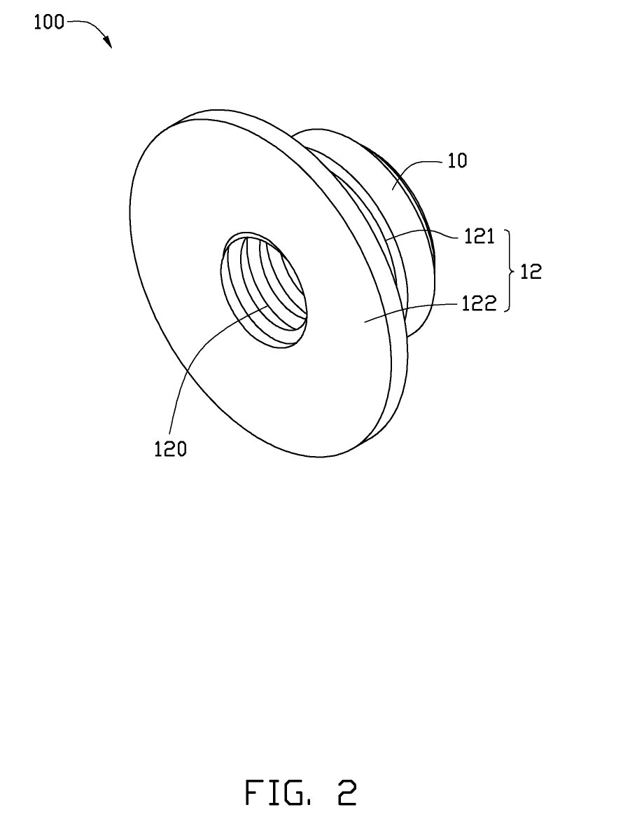

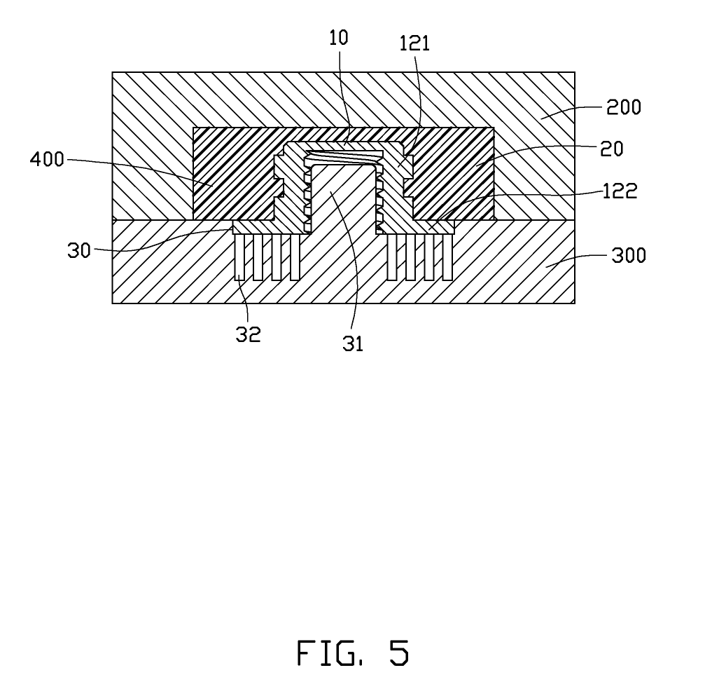

Referring to FIGS. 1 and 2, a nut 100 is disclosed as an exemplary embodiment. The nut 100 is embedded in a cover of an electronic device (shown in FIG. 5) by molding. The nut 100 includes a cap 10, and a body 12 defining a threaded hole 120. The body 12 includes an engaging section 121 and a chassis 122. The threaded hole 120 penetrates the chassis 122 and the engaging section 121. The end of the threaded hole 120 away from the chassis 122 is covered by the cap 10. In the embodiment, the chassis 122 is disk-shaped, and the diameter of the chassis 122 is larger than that of the engaging section 121. In an alternative embodiment, the diameter of the chassis 122 is equal to that of the engaging section 121.

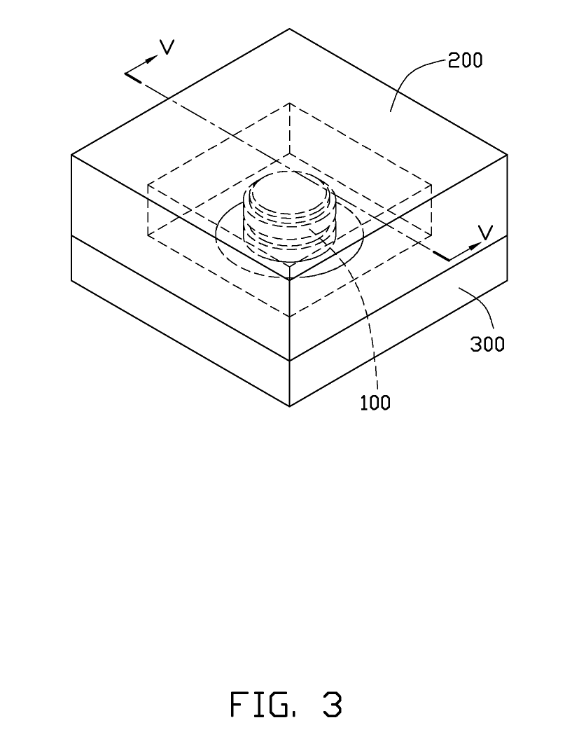

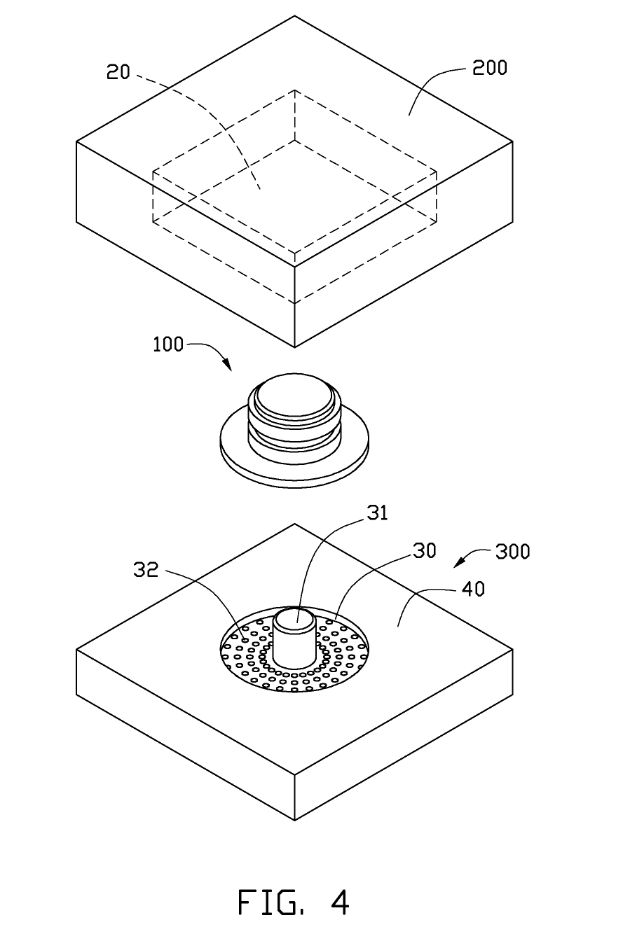

Referring to FIG. 3, a core mold 300 and a cavity mold 200 for molding the nut 100 and the cover of an electronic device are shown together. Referring to FIG. 4, the cavity mold 200 defines a molding cavity 20. The core mold 300 includes a molding surface 40 and defines a recess 30 in the molding surface 40. A post 31 protrudes from the bottom of the recess 30 and protrudes beyond the molding surface 40. The depth of the molding cavity 20 is greater than the height of the post 31. The diameter of the post 31 is slightly smaller than that of the threaded hole 120 of the nut 100. The recess 30 is circular and the diameter of the recess 30 is slightly larger than the chassis 122 of the nut 100. The core mold 300 further defines at least one suction hole 32 in the bottom of the recess 30. The at least one suction hole 32 communicates with the recess 30. In the embodiment, a number of sets of suction holes 32 are formed in the recess 30. The suction holes 32 are arranged along a number of imaginary circles. The imaginary circles are concentric.

In the embodiment, the depth of the cavity 20 is greater than the height of the nut 100. Thus, after molding, the cap 10 and the engaging section 121 are embed in the cover 400 of the electronic device, and the chassis 122 resides on the inner surface of the cover 400. In an alternative embodiment, the number and the location of the suction holes 32 may vary according to actual need. The chassis 122 may be other shapes, such as rectangular, and the recess 30 may be rectangular to match the chassis 122 accordingly.

Referring to FIGS. 3-5, during the molding, the cavity mold 300 is positioned, and the nut 100 is sleeved on the post 31. The nut 100 is then pressed down until the chassis 122 is received in the recess 30 of the core mold 300. The chassis 122 is drawn to abut tightly against the bottom of the recess 30 when all the air in the recess 30 and the suction holes 32 of the core mold 300 is drawn out from the cavity 20 via an exhaust device (not shown). Then the cavity mold 200 is assembled on the core mold 300. The molding material is then injected into the cavity 20 to mold the cover 400 with the nut 100 embed therein.

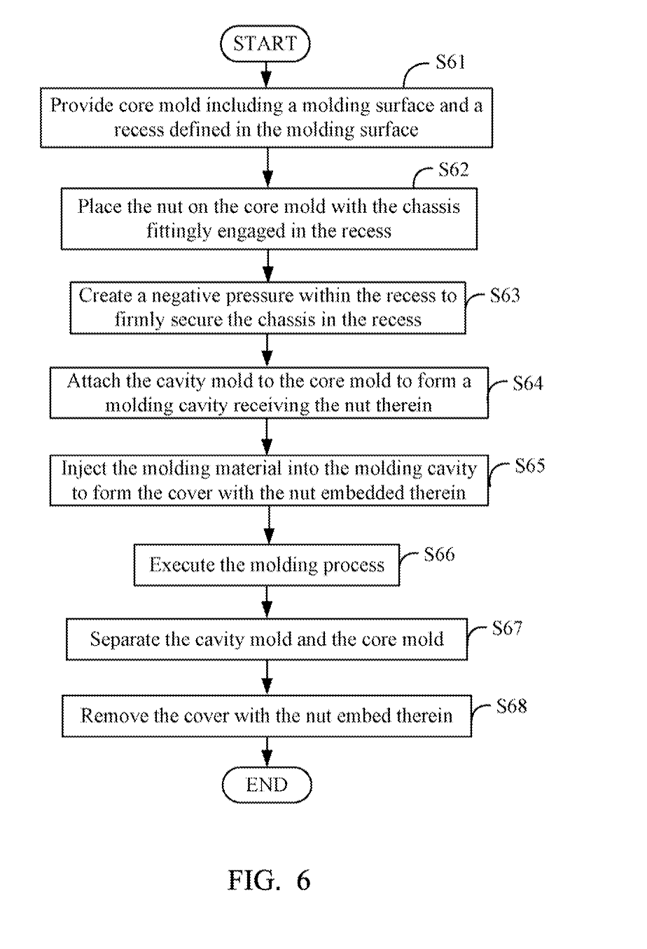

Referring to FIG. 6, a flowchart of a method for inert molding the nut 100 into a cover 400 is shown. The method includes the following steps.

In step S61, a core mold 300 is provided, which includes a molding surface 40 and a recess 30 defined in the molding surface 40.

In step S62, the nut 100 is placed on the core mold 300 with the chassis 122 fittingly engaged in the recess 30.

In step S63, a negative pressure is created within the recess 30 to firmly secure the chassis 122 in the recess 30.

In step S64, the cavity mold 200 is attached to the core mold 300 to form a molding cavity 20 receiving the nut 100 therein.

In step S65, molding material is injected into the molding cavity 20 to form the cover 400 with the nut 100 embedded therein.

In step S66, executing the molding process.

In step S67, separating the cavity mold 200 and the core mold 300.

In step S68, removing the cover 400 with the nut 100 embed therein.

Because it is drawn to abut tightly against the bottom of the recess 30, the nut 100 can be accurately positioned and can then be accurately embed within the cover 400.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A method for molding a nut into a cover of an electronic device, the nut comprising a chassis defining a threaded blind hole therein, the method comprising:
providing a core mold, the core mold including a molding surface and a recess defined in the molding surface;
placing the nut on the core mold with the chassis fittingly engaged in the recess;
creating a negative pressure within the recess to firmly secure the chassis in the recess;
attaching a cavity mold to the core mold, the cavity mold and the core mold cooperatively forming a molding cavity receiving the nut therein; and
injecting molding material into the molding cavity to form the cover with the nut embedded therein.

2. The method as described in claim 1, wherein the core mold comprises a post formed on a bottom of the recess, and the post is inserted into the blind hole.

3. The method as described in claim 1, wherein the core mold includes a plurality of holes defined in the molding surface in the recess, the holes is configured for connection to a vacuum pump to create the negative pressure.

4. A molding device for molding a nut into a cover, the molding device comprising:
a cavity mold; and
a core mold, the core mold and the cavity mold cooperatively defining a molding cavity, the core molding including a molding surface in the molding cavity, a recess defined in the molding surface, and at least one suction hole defined in a bottom of the recess, the core mold including a post protruding from the bottom of the recess and protruding beyond the molding surface.

5. The molding device as described in claim 4, wherein the at least one suction hole comprises a plurality of holes, and the holes are arranged along a plurality of imaginary circles.

6. The molding device as described in claim 5, wherein the imaginary circles are concentric.
